(19) United States
(12) Patent Application Publication
(10) Pub. No.: US 2005/0173224 A1
(43) Pub. Date: Aug. 11, 2005

(54) Positive drive handrail assembly

(75) Inventor: A. Stuart Caunce, Cobourg (CA)

Correspondence Address: BERESKIN AND PARR, 40 KING STREET WEST, BOX 401, TORONTO, ON, M5H 3Y2, CA

(73) Assignee: Ronald H. Ball, Cameron (CA)

(21) Appl. No.: 11/034,853

(22) Filed: Jan. 14, 2005

Related U.S. Application Data
(60) Provisional application No. 60/536,726, filed on Jan. 16, 2004.

(51) Int. Cl. B66B 23/22

(52) U.S. Cl. 198/337

(57) ABSTRACT

This invention provides an improved handrail construction for escalators and moving walkways that enables the handrail to be advance by positive drive forces so as to reduce the amount of stress on the handrail structure and to improve the durability of escalator handrail systems. The handrail includes teeth for engaging a drive mechanism, the teeth preferably being formed in the body of the handrail.

### FIELD OF THE INVENTION

This invention relates to moving handrails for escalators, moving walkways and similar transportation apparatus. More particularly, the invention relates to a positive drive assembly for moving handrails for such transportation apparatus.

### BACKGROUND OF THE INVENTION

Handrails for escalators, moving walkways and other similar transportation enable passengers to travel safely between the floors or along the corridors of a building. To operate safely, the handrail must move uniformly with the escalator stairs or walkway and provide a firm grip for the passengers. Structurally, the handrail must be strong enough to withstand high tensile and compressive forces imposed by the drive mechanism of the escalator system. In use, an escalator handrail drive mechanism must operate without slippage between the handrail and drive mechanism so that the handrail is not damaged by friction and wear from the drive.

A common conventional handrail has a C-shaped profile and utilizes a tensile element, usually a plurality of steel cables, disposed between plies of fabric and rubber to satisfy the strength and flexibility requirements. Unfortunately, this type of laminated structure can be costly to manufacture since the extra plies of fabric must be coated with adhesive and adhered to the adjacent plies and hard rubber layers. In many instances, the bond between the plies and tensile elements cannot withstand the drive forces imposed by a drive mechanism. As a result, the plies of the handrail may delaminate causing the handrail to slip or disintegrate. More recent handrail constructions, developed by the assignee of the present invention, have an extruded thermoplastic body with steel reinforcing cables providing a stretch inhibitor. This improvement removes the possibility of delamination but the problem of wear due to friction and slippage between it and the drive remain.

Conventionally, handrails include a low friction fabric provided along an inner surface of the handrail to enable the handrail to slide easily along a guide in the longitudinal direction of an escalator or moving walkway. As the escalator drive depends on the grip between its surface and the low friction fabric, this further makes the task of driving the handrail more difficult.

Older escalators had the handrail pass around a large diameter pulley forming the newel end of the balustrade that engages the inside surface of the handrail. This type of drive was used on units with solid balustrades that hid the wheel from view and is still used on some heavy duty units.

With the introduction of the glass balustrade, the drive mechanism was moved out of sight to the return run of the handrail. One method of achieving this was to bend the handrail backwards so that it could then be looped around a drive pulley located below the steps. While this design provides adequate transmission of drive forces, passing the handrail through a reverse bend can cause high stresses, which shorten the overall life of the handrail. Additionally, the drive pulley location makes replacement of the endless handrail difficult without considerable dismantling of the escalator.

Another drive used for glass balustrade units utilizes a linear drive mechanism, in which the handrail is simply fed through one or more pairs of rollers. Each pair of rollers comprises a follower or pressure roller and a drive roller that engages the fabric lining on the inside of the handrail to advance the handrail. To ensure the efficient transmission of the drive forces to the handrail, the pairs of rollers are pressed together with very high forces. In many instances, the stresses generated by the nip between the pair of rollers can cause the handrail to delaminate and fail or to run too hot for practical purposes. The deformation of the handrail body may also result in damage occurring to the drive mechanisms of the escalator system and significant costs associated with the repair of the system. Regardless of the drive type, the friction between the drive surface and the inner fabric surface of the handrail is relied upon to advance the handrail. While the slippage at the interface may be very low it is nonetheless the primary area of wear in a handrail and deterioration of the slider fabric is the biggest reason for handrails requiring replacement.

Accordingly, there is a need for a handrail for escalators and moving walkways that is capable of being advanced by positive drive force so as to ensure that the handrail travels at the same speed as the drive means; reduce the amount of stress on the handrail body; reduce the wear and tear on the handrail slider; and to improve the durability of escalator systems.

### SUMMARY OF THE INVENTION

This invention provides an improved handrail construction for escalators and moving walkways that enables the handrail to be advanced by positive drive forces so as to reduce the amount of stress on the handrail structure and to improve the durability of the handrail and drive.

In accordance with the first aspect of the present invention, there is provided a moving handrail for an escalator or a moving walkway, the handrail including an elongate drive portion comprising a plurality of teeth spaced apart along the length of the handrail, for driving engagement with teeth of a drive mechanism.

It will be understood that in the specification, including the claims, reference to “teeth” includes a reference to any structure that is functionally equivalent to a series of spaced apart teeth either on a drive wheel, on the drive mechanism, or the drive portion of the handrail itself. Thus, in one embodiment of the invention, teeth can be formed in the bottom surface of the handrail by providing a series of sockets or recesses in the bottom of the handrail, so that the handrail body between these sockets or recesses provides the teeth, for engaging corresponding teeth of a drive wheel or the like.

Preferably, the handrail has a handrail body formed from a solid material and a stretch inhibitor embedded in the solid material, the solid material being sufficiently elastic to permit the required bending of the handrail in use. The teeth are then formed in the body of the handrail. Unlike other, known proposals, this avoids the necessity to provide a complex structure with numerous additional elements and provide any drive function. Conveniently, the solid material of the body of the handrail comprises one of a thermoset and a thermoplastic material.

Following conventional handrail practice, the handrail can include a T-shaped slot, with a plurality of teeth formed in a bottom surface of the handrail, partially defining the T-shaped slot.

In this case, the teeth can either project from the bottom surface of the handrail, or alternatively, as mentioned above, the slot can include a plurality of recesses or sockets alternating with the teeth in the handrail bottom surface. The teeth are then, preferably, either flush with the bottom surface of the handrail, or recessed slightly back from it, so that the handrail can be used on conventional handrail guides without modification.

All or part of the inside of the T-shaped slot can be lined with a slider fabric or with a low friction polymer. Contact areas of the drive portion can comprise a hard thermoplastic material, optionally including fiber reinforcement. Where a slider fabric is used, it can extend over the drive portion and the teeth of the drive portion, or alternatively it can be provided in two strips on either side of the drive portion.

The present invention further provides a drive mechanism including at least one tooth drive member, for engaging the teeth of the drive portion of a handrail. The drive mechanism can include an endless belt provided with the drive teeth, whereby a length of the endless belt can engage a corresponding length of the handrail to drive the handrail.

A further embodiment of the present invention provides a linear drive mechanism for a handrail as defined, the drive mechanism comprising at least one drive wheel having teeth for engaging the teeth of the drive portion and at least one follower roller for pressing the handrail against the drive wheel. Preferably, such a linear drive mechanism includes a plurality of pairs of drive wheels and follower rollers, each drive wheel including teeth for engaging the teeth of the handrail drive portion. Such an arrangement should enable the pressure applied by each follower roller to be reduced considerably, since transfer of a driving force to the handrail is now through the tooth mechanism, rather than relying on friction alone between the drive wheels and the handrail.

### BRIEF DESCRIPTION OF THE FIGURES

For a better understanding of the present invention and to show clearly how it may be carried into effect, reference will now be made, by way of example, to the accompanying drawings, which show a preferred embodiment of the present invention, in which:

FIG. 1 is a cross-sectional view though a handrail made in accordance with a first embodiment of the present invention;

FIG. 2 is a perspective view of a row of teeth along the longitudinal axis A-A;

FIG. 3 is a perspective view of an alternative embodiment with two rows of teeth along the longitudinal axis A-A;

FIG. 4 is a transverse sectional view of the handrail made in accordance with a second embodiment of the present invention;

FIG. 5 shows a detail of FIG. 4 on an enlarged scale;

FIG. 6 shows a toothed strip of the present invention;

FIG. 7 shows the toothed strip of FIG. 6 attached to the underside of a C-shaped handrail;

FIG. 8 shows a drive wheel for a drive means of the present invention; and

FIG. 9 shows a drive wheel, idler wheel and belt for a drive means of the present invention.

### DETAILED DESCRIPTION OF THE INVENTION

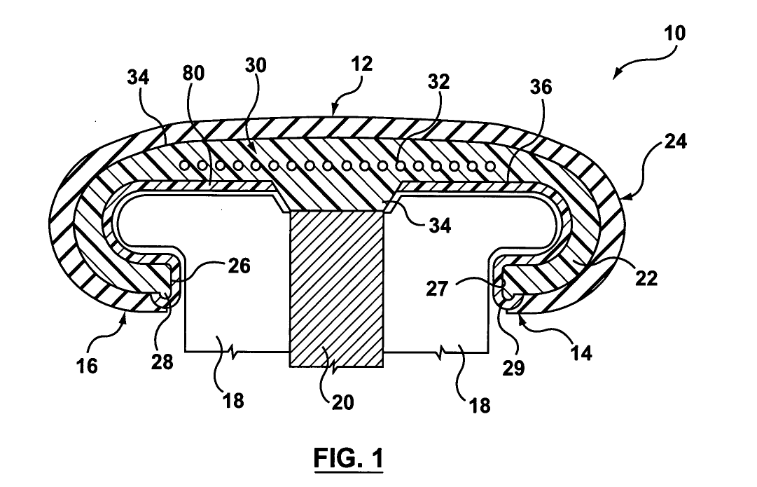

Reference is first made to FIG. 1 which illustrates a positive drive handrail for an escalator or moving walkway made in accordance with the present invention. The handrail 10 is shown as it would extend along the top, horizontal run of a handrail installation.

The handrail 10 has a generally C-shaped cross-section with a transverse section 12 and opposing inwardly directed lip portions 14 and 16. The opposing lip portions 14 and 16 assist in positioning the handrail on a guide 18 or a drive means 20. The body of the handrail 10 comprises an inner layer 22 and an outer layer 24 of a rubber (a thermoset material) or thermoplastic material. The layers 22 and 24 may extend from opposing lip portion 14 across the transverse section 12 and around to the other opposing lip portion 16. The inner layer 22 terminates at a pair vertical end surfaces 26 and 27 and ribs 28, and 29 of the lip portions 14 and 16. The layers 22 and 24 bond directly to one another at an interface 34 to form a continuous rubber or thermoplastic body. The layers 22 and 24 may be of uniform thickness throughout the C-shaped section. However, it is understood that with certain types of handrail constructions the thickness of the layers may vary.

A stretch inhibitor 30 is provided longitudinally along the handrail 10 and through the inner layer 22 of the transverse section 12. The stretch inhibitor 30 is embedded in the inner layer 22 and adhered thereto with a suitable adhesive. As shown in FIG. 1, the stretch inhibitor 30 comprises a plurality of individual spaced apart steel cables or wires 32. It is understood that the stretch inhibitor 30 may be made from any standard types of tensile reinforcement elements commonly used in a handrail body, for example any continuous load bearing element, such as, steel tape, Kevlar or ribbons of high tensile strength monofilaments and the like.

When the terms transverse and longitudinal are used with reference to the handrail, the longitudinal direction is understood to be the direction of travel of the handrail and is generally of larger magnitude than the transverse direction which is perpendicular to the direction of travel of the handrail.

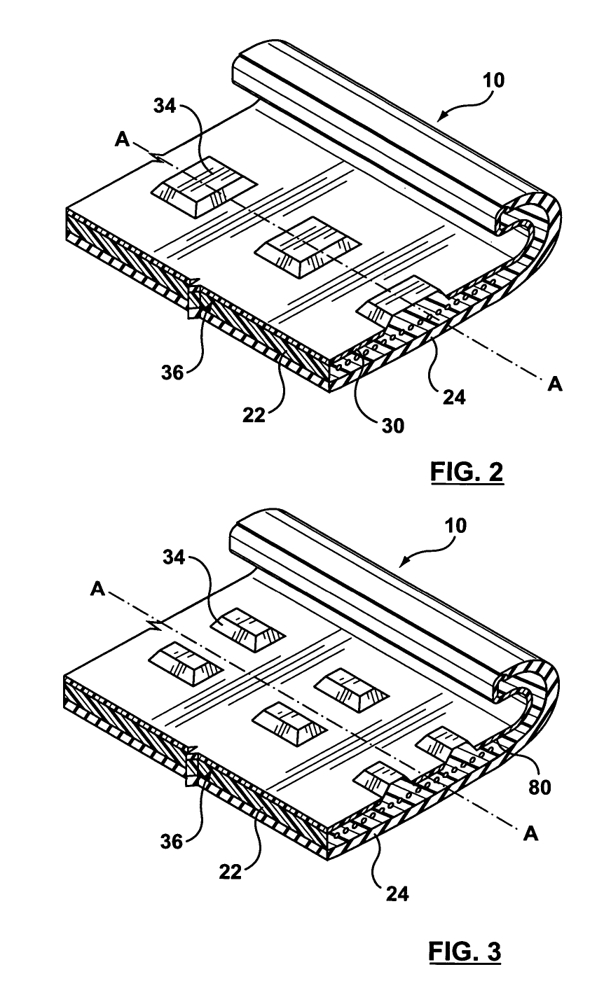

Now, in accordance with a first embodiment, of the present invention, the handrail 10 is provided with a plurality of teeth 34 which engage with the drive means 20 to drive the handrail 10. The plurality of teeth 34 extend generally perpendicularly from an inner surface 36 of the inner layer 22. In use in the orientation of FIG. 1, the inner surface forms a bottom surface of the handrail and partially defines a T-shaped slot that forms part of a conventional handrail design. While the teeth 34 shown are trapezoidal in transverse and longitudinal cross-section, it is understood that any tooth cross-section that provides an engaging surface may be used, such as, for example, rectangular, pyramidal, sinusoidal cross-sections or any other geometric solid. Any conventional tooth profile, such as an involute profile, can be used. Referring to FIG. 2, the teeth 34 may be aligned in a row along the longitudinal axis A-A of the handrail 10. Alternatively, the handrail 10 may be provided with two or more longitudinal rows of teeth 34 as shown in FIG. 3.

As shown in FIGS. 1-3, the inner surface 36 of the inner layer 22 may be provided with a slider fabric 80 to minimize the friction between the inner layer 22 and the guide 18 and/or drive means 20. The slider fabric 80 may be any fabric or other material that has a reduced coefficient of the friction so as to enable the handrail 10 to slide freely along the guide 18 of the escalator system. Typically, the slider fabric 80 is an appropriate cotton or synthetic material having a suitable texture that enables a drive means 20 of a drive wheel or apparatus to engage and advance the handrail 10. The slider fabric 80 may also be used to line or cover the teeth 34 of the handrail 10 to limit any frictional wear to the surface of the teeth 34. It is also possible to provide the slider fabric in two parts on either side of the teeth 34. This will avoid the difficulty of stretching the fabric to conform to the teeth 34 without forming wrinkles, etc.

It is also possible that the slider fabric could initially be provided as continuous lining of all the T-shaped slots within the handrail 10, and that it could then be cut to allow tooth profiles to be formed, with each tooth then being partially or completely covered by the slider fabric or with no slider fabric. The cutting operations could remove discrete portions of the slider fabric, and should be done in a manner so as to prevent fraying of exposed edges of the fabric.

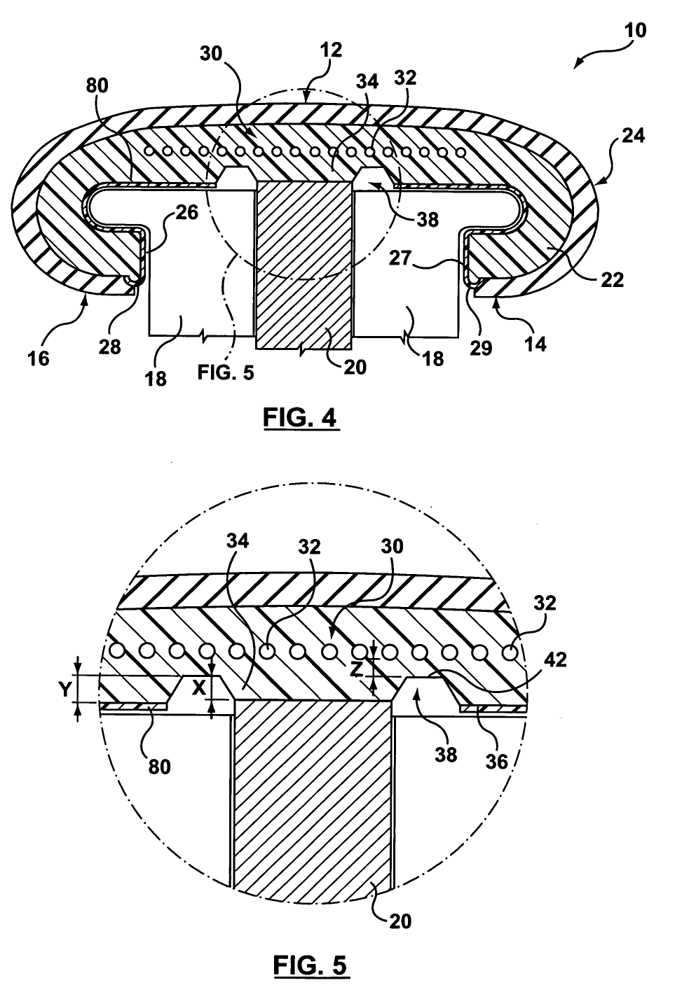

Reference is made to FIG. 4 and 5 which illustrates a second embodiment of the handrail 10 of the present invention. For simplicity, like components have been given the same reference numerals as in FIG. 1, and the description of the components is not repeated. In this second embodiment, a groove 38 is provided in the inner layer 22 along the longitudinal axis of the handrail 10. The groove 38 is provided with the teeth 34 which extend generally perpendicularly from the base surface 42 for engaging with the drive means 20, as will be discussed in greater detail below. The height X of the teeth 34 is preferably less than or equal to a depth Y of the groove 38. Furthermore, the clearance between the base surface 42 and the stretch inhibitors 30, shown as Z, should be sufficient to prevent any damage occurring to the stretch inhibitors 30, i.e. separation of them.

The use of recessed teeth 34 minimizes the frictional wear on the teeth 34 vis-à-vis the guide 18 as the handrail 10 slides along the escalator system. The handrail 10 is advanced in the longitudinal direction by the drive means 20 which is adapted to drivingly engage the teeth 34 within the groove 36. Additionally, this embodiment can be formed effectively by forming a series of recesses in the inner layer 22 of a handrail, so as in effect to leave a series of teeth flush, or just below the bottom fabric surface 80 of the handrail.

In this second embodiment, the slider fabric is shown as not extending into the groove 38, i.e. as two strips on either side. However, the slider fabric 80 could extend into the groove 38 at least up to the edge of the teeth 34. It could even cover the teeth 34, to at least some extent.

The handrail 10 made in accordance with the second embodiment of the present invention may be used to retrofit a conventional escalator. Typically, the guide on a conventional escalator has a generally planar surface that contacts the flat inner surface of the handrail. The teeth 34 are recessed into the inner layer 22 and below the level of the fabric slider surface 80 and are therefore able to slide smoothly along the planar surface of the conventional guide 18. Since the replacement of the original guide is not necessary, the costs associated with the conversion of a conventional escalator to a positive drive system would be limited.

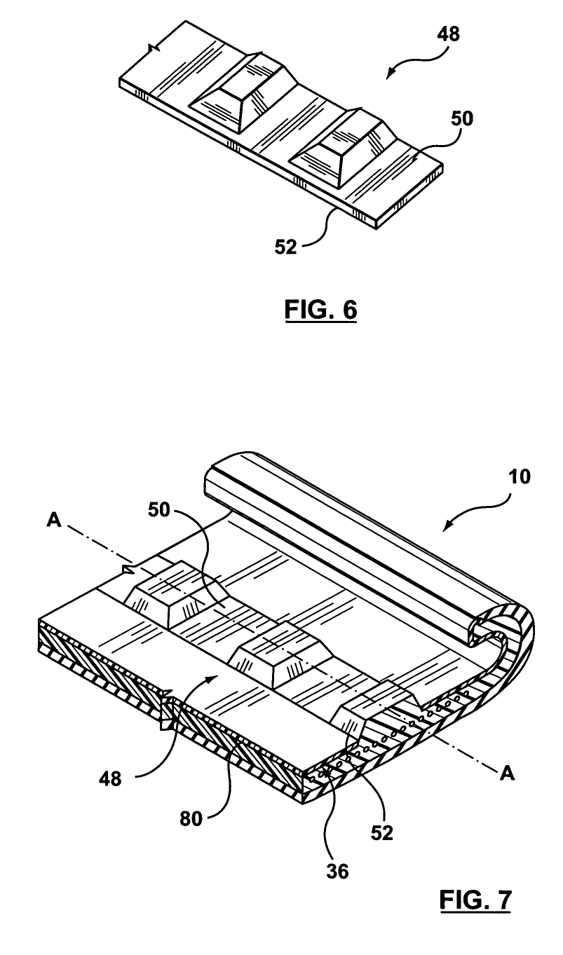

Alternatively, a conventional handrail may be retrofitted using a toothed strip 48 attached to a C-shaped handrail 110. As shown in FIGS. 6 and 7, the toothed strip 48 comprises a plurality of teeth 34 extending generally perpendicularly from a backing portion 50. The backing portion 50 has an attachment surface 52 that can be attached or adhered to an inner surface 36 or bottom fabric surface 80 of the standard handrail 110. By this design, a conventional escalator can be converted to a positive drive handrail system efficiently and cost effectively using the toothed strip 48 and a suitable drive means. This would require modification of the guide along the length of the escalator.

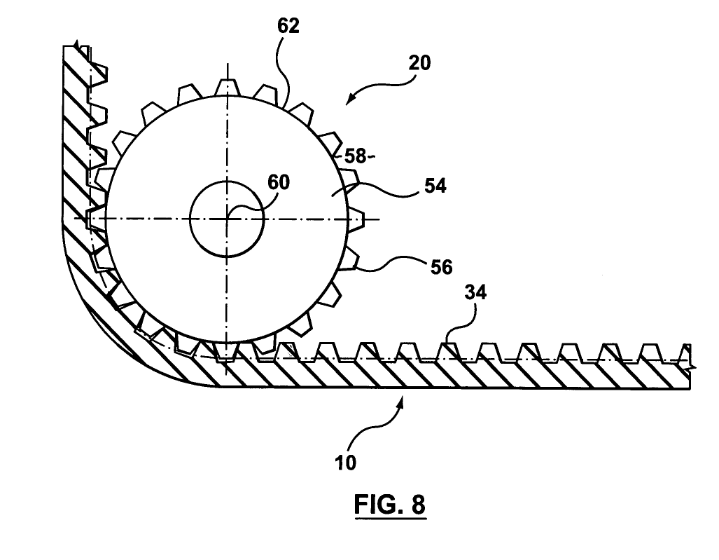

Reference will now be made to FIG. 8 which illustrates a drive means 20 for use with the handrail 10 of the present invention. The drive means 20 may comprise a drive wheel 54 having a plurality of teeth 56 and recesses 58 and a drive shaft 60 forming an axis of rotation. The teeth 56 and recesses 58 are formed on an outer surface 62 of the drive wheel 54 and extend generally radially from the axis. The recesses 58 are adapted to engagingly receive the teeth 34 provided on the handrail 10 so as to positively drive the handrail 10 in a forward or reverse direction. Preferably, the size and circumferential spacing of the cogs or teeth 56 and recesses 58 correspond to the associated teeth 34 on the handrail 10. The teeth 56 can have any standard profile and can be involute in form.

The use of a positive drive handrail system minimizes the need for large amounts of normal or engagement force being applied to the surface of the handrail to create enough friction between the inner surface of the handrail and the drive means to properly advance the handrail. Additionally, the minimization of slippage will ensure that the handrail 10 and the escalator stairs travel at the same speed.

It is noted that the drive wheel 54 is preferably provided with a tread of rubber or other elastomer of suitable hardness and wear resistance to increase the coefficient of friction between it and the handrail and reduce slippage.

FIG. 8 shows the handrail 10 extending through a substantial angle around the drive wheel 54, by way of example. However, an advantage of the present invention is that it should be possible to use it in situations with much smaller angles of wrap or in a linear drive arrangement, with one or more drive rollers and corresponding pressure or locating roller(s), with much reduced or no pressure on the handrail as they would only be required to maintain the handrails location in relation to the drive wheel rather than create friction by pressing the handrail against the drive.

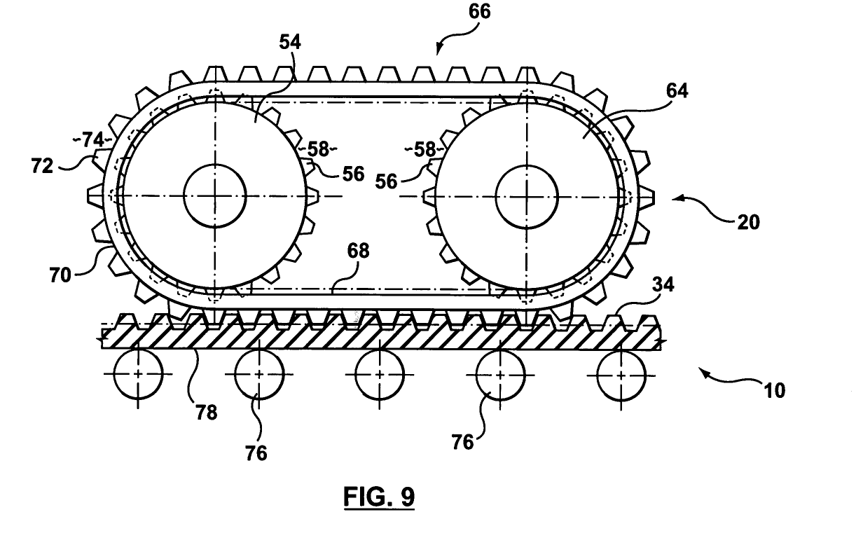

Referring to FIG. 9 the drive means 20 may alternatively comprise a drive wheel 54, an idler wheel 64 and an endless belt 66. A pair of drive wheels may be used for escalator or moving walkway applications that experience heavy impact and/or bearing loads. The drive and idler wheels 54 and 64 are provided with a mating surface corresponding to the inner drive surface 68 and this may be a plurality of cogs 56 and recesses 58 as previously described or some other mating surface such as a multiple V configuration. The belt 66 is disposed extending around the wheels 54 and 64 and is driven by the drive wheel 54. The belt 66 is provided with a drive surface 68 and an operative surface 70 for driving the handrail 10. The drive surface 68 may have any configuration that is capable of being engaged by the drive and idler wheels 54 and 64. The operative surface 70 may be provided with a plurality of mating teeth 72 and mating recesses 74 that are adapted to be engagingly received by the teeth 34 formed on the handrail 10.

The belt is rotatably driven beside the handrail 10 so that the mating recesses 74 on the operative surface 70 of the belt 66 engagingly receive the teeth 34 on the handrail 10. The engagement of the teeth 34 and mating recesses 74 causes the handrail 10 to travel as a direct result of the velocity of rotation of the drive wheel 54.

The use of a parallel handrail and belt configuration is beneficial because it increases the contact area between the drive means 20 and the handrail 10, thereby maximizing the drive force transmission. Furthermore, increasing the contact area between the belt 66 and handrail 10 minimizes the amount of fatigue and wear on the escalator system.

As shown in FIG. 9, the handrail 10 may also be supported by one or more follower rollers 76 as it is engaged by the drive means 20, or the follower rollers can comprise a follower belt supported on rollers. The follower rollers 76 contact an upper portion 78 of the handrail 10 (shown inverted) and guide the handrail 10 between the drive wheel 54 and the follower rollers 76. Unlike in a conventional linear drive system, the follower rollers 76 largely support the upper portion 78 of the handrail 10 as the teeth 34 are engagingly received in the drive means 20, and lower or no pressure will be required.

Alternatively, for a linear drive mechanism, there can be provided a plurality of pairs of toothed drive wheels and follower rollers.

The high pressure exerted by the drive and pressure rollers of conventional linear drive systems often cause the handrails to deteriorate as a result of dirt and debris being driven into the surface of the handrail. In many instances the application of an excessive normal force causes the handrail to buckle or warp along the longitudinal axis. The use of a positive drive system made in accordance with the present invention reduces the drive force that is required to advance to the handrail 10 and minimizes the occurrence of frictional damage to the body of the handrail 10.

The longevity of the handrail 10 as a whole may also be increased by utilizing more durable rubber or thermoplastic materials for the teeth 34 and layers 22 and 24. Preferably, the teeth 34 and inner layer 22 are integrally formed from a rubber or thermoplastic material having the same characteristics. In some escalator and moving walkway applications, the inner and outer layers 22 and 24 of the handrail will have different characteristics or hardnesses. The inner layer 22 is formed from a harder and generally stiffer material so that the teeth 34 do not deteriorate. Conversely, the outer layer 24 is generally a softer grade of rubber or thermoplastic material than the inner layer 22. One possible arrangement of the properties of the two layers 22 and 24 are given in the following table:

TABLE 1

| | Inner Layer | | Outer Layer | |
|---|---|---|---|---|
| Hardness | 40-50 | Shore ‘D’ | 70-85 | Shore ‘A’ |
| 100% Tensile Modulus | 11 | Mpa | 5.5 | Mpa |
| Flexural Modulus | 63 | Mpa | 28 | Mpa |
| Shear Modulus | 6-8 | MN/m² | 4-5 | MN/m² |

The harder and generally stiffer material used to form the inner layer 22 serves to retain the dimensions of the lip portions 14 and 16 of the handrail 10, including the spacing between the vertical end surfaces 26 and 28 of the lip portions 14 and 16. Additionally, the stiffer material improves the drive force transmission to the teeth 34 from the drive means 20.

It is understood that various handrail cross-section may be used in combination with the present invention, such as, for example, a handrail body comprising a plurality of fabric plies and rubber as defined in U.S. Pat. No. 5,255,772. Alternatively, a handrail may be formed solely from one layer of rubber or thermoplastic material rather than a laminated structure. The material of the teeth can include fiber reinforcement.

Further, while the teeth 34 have been shown defined by flat faces meeting at relatively sharp angles, it will be understood that the overall shape of the teeth 34 can be more rounded to avoid sharp angles and possible stress concentration.

It is preferred for a handrail in accordance with the present invention to be manufactured by extrusion. Following extrusion, the body of the handrail is usually still relatively soft and is subject to a sizing and cooling process. During this process, the teeth for the drive portion of the handrail can be formed. The initially extruded profile and dimensions of the handrail should accordingly be selected to accommodate the material required to be displaced to form the teeth of the drive portion. More specifically, the profile must correspond to the different embodiments where the teeth project from the bottom surface of the handrail and where recesses are formed in the bottom surface of the handrail to define teeth that are otherwise flush with the bottom surface.

Where the slider fabric is provided in strips on either side of the drive portion, and not over the teeth themselves, forming of the teeth should be relatively straightforward. Where it is desired for the slider fabric to extend over the teeth, it will be necessary to ensure that there is sufficient slack or play in the slider fabric that the necessary tooth profiles can be formed, or as mentioned, the slider fabric can be cut. For example, cutting a synthetic slider material with a laser beam should enable it to be cut precisely while heat sealing edges of the fabric.

In addition to using a fabric as a low friction slider material on the inside of the handrail, it is also possible to use a low friction polymer.

While what has been shown and described herein constitutes a preferred embodiment of the subject invention, it should be understood that various modifications and adaptations of such embodiment can be made without departing from the present invention, the scope of which is defined above

1. A moving handrail for an escalator or moving walkway, the handrail including an elongate drive portion comprising a plurality of teeth spaced apart along the length of the handrail, for driving engagement with teeth of a drive mechanism.

2. A handrail as claimed in claim 1, wherein the handrail has a handrail body formed from a solid material and a stretch inhibitor embedded in the solid material, the solid material being sufficiently elastic to permit required bending of the handrail in use, wherein the teeth are-formed in the body of the handrail.

3. A handrail as claimed in claim 2, wherein the solid material of the body of the handrail comprises one of a thermoset and a thermoplastic material.

4. A handrail as claimed in claim 3, where in the handrail includes a T-shaped slot and wherein the plurality of teeth are provided in a bottom surface of the handrail, partially defining the T-shaped slot.

5. A moving handrail as claimed in claim 4, wherein the teeth project from the bottom surface of the handrail.

6. A handrail as claimed in claim 4, wherein the bottom surface of the slot includes a plurality of recesses alternating with the teeth in the bottom surface of the handrail, with the teeth flush with or recessed back from the bottom surface of the handrail.

7. A handrail as claimed in claim 4, 5 or 6, wherein at least contact areas of the drive portion comprises a hard thermoplastic material.

8. A moving handrail as claimed in claim 4, 5 or 6, wherein at least contact areas of the drive portion of the handrail comprise a thermoplastic material including fiber reinforcement.

9. A moving handrail as claimed in claim 4, including a slider fabric at least partially lining the T-shaped slot.

10. A moving handrail as claimed in claim 9, wherein the slider fabric extends over the drive portion and the teeth of the drive portion.

11. A moving handrail as claimed in claim 9, wherein the slider fabric is provided in at least two strips, on either side of the drive portion, whereby the teeth of the drive portion are not covered by the slider fabric.

12. A combination of a handrail as claimed in claim 1 and a handrail drive mechanism including at least one toothed drive member, whereby the toothed drive member is arranged to engage the-drive portion of the handrail with minimum engagement force.

13. A combination as claimed in claim 12, wherein the drive mechanism includes at least a toothed wheel engaging the teeth of the drive portion.

14. A combination as claimed in claim 12, wherein the drive mechanism includes an endless belt, including teeth for engaging the teeth of the drive portion of the handrail along a length of the handrail.

15. A linear drive mechanism for a handrail including a drive portion having spaced apart teeth, the drive mechanism comprising at least one drive wheel having teeth for engaging the teeth of the drive portion and at least one follower roller for pressing the handrail against the drive wheel.

16. A linear drive mechanism as claimed in claim 15, including a plurality of pairs of drive wheels and follower rollers, each drive wheel including teeth for engaging the teeth of the handrail drive portion.

17. A linear drive mechanism for a handrail including a drive portion having spaced apart teeth, the linear drive mechanism comprising an endless drive belt having teeth for engaging the teeth of the drive portion of the handrail, at least two wheels mounting and driving the endless drive belt and engaging a straight portion of the endless drive belt with the drive portion of the handrail.

18. A linear drive mechanism as claimed in claim 17, wherein said at least two wheels comprise a drive wheel and an idler wheel, and wherein a plurality of follower rollers and a follower belt are provided, to maintain the endless drive belt engaged with the drive portion of the handrail.
